(19) United States
(12) Patent Application Publication
(10) Pub. No.: US 2026/0310479 A1
(43) Pub. Date: Oct. 8, 2026

(54) METHOD AND SYSTEM OF REMOVING LANGUAGE BARRIERS FROM DIGITAL INTERFACE-GENERATED OBJECTS

(71) Applicant: JPMorgan Chase Bank, N.A., New York, NY (US)

(72) Inventors: Scott QUINLIN, Montgomery, TX (US); Kevin J. MCNAMARA, Newfoundland, NJ (US); Mario MACIAS, Plano, TX (US); Dejan SAVIC, Burleson, TX (US); Elizabeth PARK, Frisco, TX (US); Rohit TALREJA, Hyderabad (IN); Preeti GUPTA, Plano, TX (US)

(73) Assignee: JPMorgan Chase Bank, N.A., New York, NY (US)

(21) Appl. No.: 19/212,055

(22) Filed: May 19, 2025

(30) Foreign Application Priority Data
Apr. 4, 2025 (IN) 202511033195

(51) Int. Cl. G06F 9/451; G06F 40/263; G06F 40/58

(52) U.S. Cl. CPC G06F 9/454; G06F 40/263; G06F 40/58

(57) ABSTRACT

A system is presented that implements a digital interface language barrier removal tool. The system may be configured to: obtain user-specific data; evaluate the user-specific data to identify a user-specific language; evaluate a digital interface to identify a digital interface-specific language, and a first set of language-specific objects that are generated by the digital interface; when the digital interface-specific language has been determined to be distinct from the user-specific language, utilize the user-specific language to generate a second set of language-specific objects that comprises a user-specific translation of at least one respectively corresponding language-specific object from among the first set of language-specific objects; and modify, the first set of language-specific objects, by utilizing the second set of language-specific objects to replace the at least one respectively corresponding language-specific object, respectively.

### CROSS-REFERENCE TO RELATED APPLICATIONS

This application claims priority benefit from Indian Application No. 202511033195, filed Apr. 4, 2025, which is hereby incorporated by reference in its entirety.

### BACKGROUND

### 1. Field

This disclosure generally relates to digital interface objects and, more particularly, to a method, system and computer-readable medium that removes language barriers from digital interface-generated objects.

### 2. Background

Modern computerized electronic systems interact with users via a digital interface that provides access to various features and functions of the computerized electronic system(s). Indeed, such computerized electronic systems have become ubiquitous in the technology industry.

However, the users of these computerized electronic systems are not a monolith. On the contrary, they originate from various backgrounds and, therefore, utilize various languages and dialects to send and receive communications. Unfortunately, such variations raise issues when a computerized electronic system's digital interface does not conform to a language or dialect in which its user is able to communicate.

Therefore, there is a need in the field of the present disclosure, for a technological improvement that addresses this drawback and provides a technical solution to the language barriers that arise during the use of conventional computerized electronic system digital interfaces.

Accordingly, the approach disclosed herein is presented to improve the field of the present disclosure by addressing the above-mentioned problem that exists in today's computerized electronic system digital interfaces.

### SUMMARY

The present disclosure, through one or more of its various aspects, embodiments, and/or specific features or sub-component, provides, inter alia, various systems, servers, devices, methods, media, programs and platforms for implementing event consumer application deployment control within at least one electronic event mesh.

According to an aspect of the invention, a method is provided that implements a digital interface language barrier removal tool. The method may comprise: obtaining user-specific data that corresponds to a user; identifying, by analyzing the user-specific data, at least one user-specific language; identifying, by analyzing at least one digital interface of the user, at least one digital interface-specific language and a first set of language-specific objects that are generated, by the at least one digital interface, according to the at least one digital interface-specific language; when the at least one digital interface-specific language has been determined to be distinct from the at least one user-specific language, utilizing the at least one user-specific language to generate a second set of language-specific objects that comprises at least one user-specific translation of at least one respectively corresponding language-specific object from among the first set of language-specific objects; and modifying, the first set of language-specific objects, by utilizing the second set of language-specific objects to replace the at least one respectively corresponding language-specific object, respectively.

In the method, the first set of language-specific objects may comprise at least one from among a label, a menu, a form, and a feedback prompt.

In the method, the obtaining of the user-specific data may comprise obtaining the user-specific data in real time from at least one from among a keyboard and a microphone.

The method may further comprise generating at least one response to the user-specific data according to the user-specific language.

In the method, the at least one user-specific language may comprise at least one from among a first language, a first dialect and an indication of a first root origin of the user.

In the method, the identifying of the at least one user-specific language may comprise: when the first language has been determined to be distinct from at least one from among the first dialect and the first root origin of the user, determining that the at least one user-specific language corresponds to the at least one from among the first language and the first root origin of the user.

The method may further comprise utilizing at least one neural network to identify the at least one user-specific language, the at least one digital interface-specific language and the first set of language-specific objects. The at least one neural network may include at least one machine learning and artificial intelligence (AI/ML) model that is configured to identify at least one from among a language, a dialect and a root origin, by analyzing at least one from among corresponding user-specific data and at least one corresponding digital interface.

In the method, the at least one neural network may have been trained on a plurality of annotated examples of computer-generated language-specific objects.

In the method, identifying each of the at least one from among the language, the dialect and the root origin of the user, may comprise: calculating, by the at least one neural network, a confidence score that is based on a parallelized inference; when the confidence score has been determined to comprise at least a ninety-five percent confidence in the parallelized inference, associating the parallelized inference with the at least one from among the language, the dialect and the root origin of the user; and prioritizing the parallelized inference when: the at least one from among the language, the dialect and the root origin of the user comprises a plurality of parallelized inferences; and the confidence score comprises a highest confidence score that has been calculated for the plurality of parallelized inferences.

In the method, the at least one user-specific translation may comprise at least one respectively corresponding relocation of at least one language-specific object of the at least one digital interface.

According to another aspect of the present disclosure, a system is provided that implements a digital interface language barrier removal tool. The system comprises a processor and memory that stores instructions that, when executed by the processor, cause the processor to perform operations that may comprise: obtaining user-specific data that corresponds to a user; identifying, by analyzing the user-specific data, at least one user-specific language; identifying, by analyzing at least one digital interface of the user, at least one digital interface-specific language and a first set of language-specific objects that are generated, by the at least one digital interface, according to the at least one digital interface-specific language; when the at least one digital interface-specific language has been determined to be distinct from the at least one user-specific language, utilizing the at least one user-specific language to generate a second set of language-specific objects that comprise at least one user-specific translation of at least one respectively corresponding language-specific object from among the first set of language-specific objects; and modifying, the first set of language-specific objects, by utilizing the second set of language-specific objects to replace the at least one respectively corresponding language-specific object, respectively.

In the system, when executed by the processor, the instructions may cause the first set of language-specific objects to comprise at least one from among a label, a menu, a form, and a feedback prompt.

In the system, when executed by the processor, the instructions may cause the obtaining of the user-specific data to comprise the obtaining of the user-specific data in real time from at least one from among a keyboard and a microphone.

In the system, when executed, the instructions may cause the processor to perform further operations, which comprise generating at least one response to the user-specific data according to the user-specific language.

In the system, when executed by the processor, the instructions may cause the at least one user-specific language to comprise at least one from among a first language, a first dialect and an indication of a first root origin of the user.

In the system, when executed by the processor, the instructions may cause the identifying of the at least one user-specific language to comprise: when the first language has been determined to be distinct from at least one from among the first dialect and the first root origin of the user, determining that the at least one user-specific language corresponds to the at least one from among the first language and the first root origin of the user.

In the system, when executed, the instructions may cause the processor to perform further operations, which comprise utilizing at least one neural network to identify the at least one user-specific language, the at least one digital interface-specific language and the first set of language-specific objects. The at least one neural network may include at least one machine learning and artificial intelligence (AI/ML) model that is configured to identify at least one from among a language, a dialect and a root origin, by analyzing at least one from among corresponding user-specific data and at least one corresponding digital interface.

In the system, the at least one neural network may have been trained on a plurality of annotated examples of computer-generated language-specific objects.

In the system, when executed by the processor, the instructions may cause identifying each of the at least one from among the language, the dialect and the root origin of the user, to comprise: calculating, based on a parallelized inference of the at least one neural network, a confidence score; when the confidence score has been determined to comprise at least a ninety-five percent confidence in the parallelized inference, associating the parallelized inference with the at least one from among the language, the dialect and the root origin of the user; and prioritizing the parallelized inference when: the at least one from among the language, the dialect and the root origin of the user comprises a plurality of parallelized inferences; and the confidence score comprises a highest confidence score that has been calculated for the plurality of parallelized inferences.

In the system, when executed by the processor, the instructions may cause the at least one user-specific translation to comprise at least one respectively corresponding relocation of at least one language-specific object of the at least one digital interface.

According to yet another aspect of the present disclosure, a non-transitory computer-readable medium is provided that implements a digital interface language barrier removal tool. The computer-readable medium storing instructions that, when executed by a processor, cause the processor to perform operations that comprise: obtaining user-specific data that corresponds to a user; identifying, by analyzing the user-specific data, at least one user-specific language; identifying, by analyzing at least one digital interface of the user, at least one digital interface-specific language and a first set of language-specific objects that correspond to a first set of language-specific objects that are generated, by the at least one digital interface, according to the at least one digital interface-specific language; when the at least one digital interface-specific language has been determined to be distinct from the at least one user-specific language, utilizing the at least one user-specific language to generate a second set of language-specific objects that comprise at least one user-specific translation of at least one respectively corresponding language-specific object from among the first set of language-specific objects; and modifying, the first set of language-specific objects, by utilizing the second set of language-specific objects to replace the at least one respectively corresponding language-specific object, respectively.

In the computer-readable medium, when executed by the processor, the instructions may cause the first set of language-specific objects to comprise at least one from among a label, a menu, a form, and a feedback prompt.

In the computer-readable medium, when executed by the processor, the instructions may cause the obtaining of the user-specific data to comprise obtaining the user-specific data in real time from at least one from among a keyboard and a microphone.

In the computer-readable medium, when executed, the instructions may cause the processor to perform further operations, which comprise generating at least one response to the user-specific data according to the user-specific language.

In the computer-readable medium, when executed by the processor, the instructions may cause the at least one user-specific language to comprise at least one from among a first language, a first dialect and an indication of a first root origin of the user.

In the computer-readable medium, when executed by the processor, the instructions may cause the identifying of the at least one user-specific language to comprise: when the first language has been determined to be distinct from at least one from among the first dialect and the first root origin of the user, determining that the at least one user-specific language corresponds to the at least one from among the first language and the first root origin of the user.

In the computer-readable medium, when executed, the instructions may cause the processor to perform further operations, which comprise utilizing at least one neural network to identify the at least one user-specific language, the at least one digital interface-specific language and the first set of language-specific objects.. The at least one neural network may include at least one machine learning and artificial intelligence (AI/ML) model that is configured to identify at least one from among a language, a dialect and a root origin, by analyzing at least one from among corresponding user-specific data and at least one corresponding digital interface.

In the computer-readable medium, the at least one neural network may have been trained on a plurality of annotated examples of computer-generated language-specific objects.

In the computer-readable medium, when executed by the processor, the instructions may cause identifying each of the at least one from among the language, the dialect and the root origin of the user, to comprise: calculating, based on a parallelized inference of the at least one neural network, a confidence score; when the confidence score has been determined to comprise at least a ninety-five percent confidence in the parallelized inference, associating the parallelized inference with the at least one from among the language, the dialect and the root origin of the user; and prioritizing the parallelized inference when: the at least one from among the language, the dialect and the root origin of the user comprises a plurality of parallelized inferences; and the confidence score comprises a highest confidence score that has been calculated for the plurality of parallelized inferences.

In the computer-readable medium, when executed by the processor, the instructions may cause the at least one user-specific translation to comprise at least one respectively corresponding relocation of at least one language-specific object of the at least one digital interface.

Accordingly, the invention disclosed herein provides a tool that removes language barriers from digital interface-generated objects.

### BRIEF DESCRIPTION OF THE DRAWINGS

The present disclosure is further described in the detailed description which follows, in reference to the noted plurality of drawings, by way of non-limiting examples of the present disclosure, in which like characters represent like elements throughout the several views of the drawings.

FIG. 1 depicts a diagram of computer system, according to an embodiment.

FIG. 2 depicts a diagram of an environment for implementing a digital interface language barrier removal tool, according to an embodiment.

FIG. 3 depicts a diagram of an aspect of an environment that is configured to implement a digital interface language barrier removal tool, according to an embodiment.

FIG. 4 depicts a flowchart of a process for implementing a digital interface language barrier removal tool, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable storage media having instructions stored thereon for one or more aspects of the present technology as described and illustrated by way of the examples herein. In some examples, the instructions include executable code that, when executed by one or more processors, cause the processors to carry out operations necessary to implement the methods of the examples of this technology that are described and illustrated herein. Also, as described and illustrated herein, this technology may include an interface such as a voice interface, and the voice interface may perform a voice interaction, for example, with a user. However, other examples are also envisioned.

As described in further detail below, the herein-disclosed technology implements event consumer application deployment control within at least one electronic event mesh.

Accordingly, by employing the herein-disclosed technique within one or more electronic event meshes and thereby improving event consumer application deployment, the technique disclosed herein provides a technical improvement to electronic event mesh technologies.

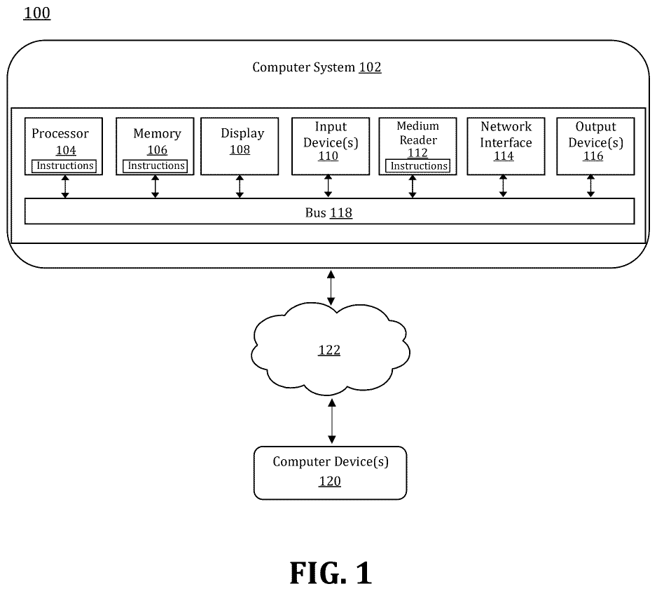

FIG. 1 is a system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for longer than a transitory period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. It should also be noted that computer device 120 may be utilized within a call center, with a short messaging service (SMS), and/or with a chat channel. Of course, those skilled in the art appreciate that the above-listed devices are merely examples and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in a non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described in further detail below, the various embodiments disclosed herein provide methods, systems and computer-readable media that remove language barriers from digital interface-generated objects.

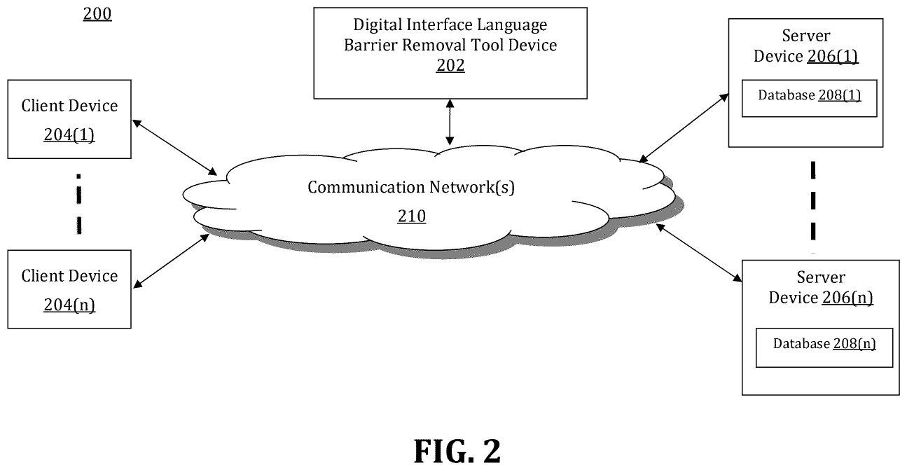

Referring to FIG. 2, a schematic of a network environment 200 for implementing a digital interface language barrier removal tool. In an embodiment, the digital interface language barrier removal tool may be implemented on any networked computer platform, such as, for example, a personal computer (PC).

A method for implementing event consumer application deployment control within at least one electronic event mesh, may be implemented by a digital interface language barrier removal tool (GLBRT) device 202. The GLBRT device 202 may be the same or similar to the computer system 102 as described with respect to FIG. 1. The GLBRT device 202 may be a rack-mounted server in a datacenter, an embedded microcontroller (MCU) in an electronic device, or another type of headless system, which is a computer system or device that is configured to operate without a monitor, keyboard and mouse. The GLBRT device 202 may store one or more applications that can include executable instructions that, when executed by the GLBRT device 202, cause the GLBRT device 202 to perform actions, such as to transmit, receive, or otherwise process network communications, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the GLBRT device 202 itself, may be located in virtual server(s) running in a cloud-based computing environment rather than being tied to one or more specific physical network computing devices. Also, the application(s) may be running in one or more virtual machines (VMs) executing on the GLBRT device 202. Additionally, in one or more embodiments of this technology, virtual machine(s) running on the GLBRT device 202 may be managed or supervised by a hypervisor.

In the network environment 200 of FIG. 2, the GLBRT device 202 is coupled to a plurality of client devices 204(1)-204(n), and also to a plurality of server devices 206(1)-206(n) that hosts a plurality of databases 208(1)-208(n) via communication network(s) 210. A communication interface of the GLBRT device 202, such as the network interface 114 of the computer system 102 of FIG. 1, operatively couples and communicates between the GLBRT device 202, the client devices 204(1)-204(n), and/or the server devices 206(1)-206(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the GLBRT device 202, the client devices 204(1)-204(n), and/or the server devices 206(1)-206(n) may be coupled together via other topologies. Additionally, the network environment 200 may include other network devices such as one or more routers and/or switches, for example, which are well known in the art and thus will not be described herein. This technology provides a number of advantages including methods, computer readable media, and GLBRT devices that implement a method for a digital interface language barrier removal tool that removes language barriers from digital interface-generated objects.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like. For the purposes of the present disclosure, it should be noted that: the term “remote” may refer to a “physical” and/or “virtual” remoteness; and the term “local” may refer to a “physical” and/or “virtual” locale.

The GLBRT device 202 may be a standalone device or integrated with one or more other devices or apparatuses, such as one or more of the server devices 206(1)-206(n), for example. In one particular example, the GLBRT device 202 may include or be hosted by one of the server devices 206(1)-206(n), and other arrangements are also possible. As another example, the GLBRT device 202 may be integrated with one or more other devices or apparatuses, such as one or more of the client devices 204(1)-204(n). Moreover, one or more of the devices of the GLBRT device 202 may be in a same or a different communication network including one or more public, private, or cloud networks, for example.

The plurality of server devices 206(1)-206(n) may be the same or similar to the computer system 102 or the computer device 120 as described with respect to FIG. 1, including any features or combination of features described with respect thereto. For example, any of the server devices 206(1)-206(n) may include, among other features, one or more processors, memories and communication interfaces, which are coupled together by at least one bus or other communication link, although other numbers and/or types of network devices may be used. The server devices 206(1)-206(n) in this example may process requests received from the GLBRT device 202 via the communication network(s) 210 according to an HTTP-based and/or JavaScript Object Notation (JSON) protocol, for example, although other protocols may also be used.

The server devices 206(1)-206(n) may be hardware or software or may represent a system with multiple servers in a pool, which may include internal or external networks. The server devices 206(1)-206(n) hosts the databases 208(1)-208(n) that are configured to store data.

Although the server devices 206(1)-206(n) are illustrated as single devices, one or more actions of each of the server devices 206(1)-206(n) may be distributed across one or more distinct network computing devices that together comprise one or more of the server devices 206(1)-206(n). Moreover, the server devices 206(1)-206(n) are not limited to a particular configuration. Thus, the server devices 206(1)-206(n) may contain a plurality of network computing devices that operate using a master/slave approach, whereby one of the network computing devices of the server devices 206(1)-206(n) operates to manage and/or otherwise coordinate operations of the other network computing devices.

The server devices 206(1)-206(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures are also envisaged.

The plurality of client devices 204(1)-204(n) may also be the same or similar to the computer system 102 or the computer device 120 as described with respect to FIG. 1, including any features or combination of features described with respect thereto. For example, the client devices 204(1)-204(n) in this example may include any type of computing device that can interact with the GLBRT device 202 via communication network(s) 210. Accordingly, the client devices 204(1)-204(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 204 is a wireless mobile communication device, i.e., a smart phone.

The client devices 204(1)-204(n) may run interface applications, such as standard web browsers or standalone client applications, which may provide an interface to communicate with the GLBRT device 202 via the communication network(s) 210 in order to communicate user requests and other information. The client devices 204(1)-204(n) may further include, among other features, a display device, such as a display screen or touchscreen, and/or an input device, such as a keyboard, for example. The client devices 204(1)-204(n) may host one or more applications that are proprietary to an enterprise that may be secured against eavesdropping, and these applications may be distributed among client devices 204(1)-204(n). The enterprise's distributed applications may include software that is based on microservices architecture, for example.

Although the network environment 200 with the GLBRT device 202, the client devices 204(1)-204(n), the server devices 206(1)-206(n), the databases 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the GLBRT device 202, the client devices 204(1)-204(n), the server devices 206(1)-206(n), and the databases 208(1)-208(n), for example, may be configured to operate as virtual instances on the same physical machine. In other words, one or more of the GLBRT device 202, the server devices 206(1)-206(n), the client devices 204(1)-204(n), and the databases 208(1)-208(n) may operate on a common physical device rather than as separate devices communicating through communication network(s) 210. Additionally, there may be more or fewer client devices 204(1)-204(n), server devices 206(1)-206(n), and databases 208(1)-208(n) than illustrated in FIG. 2.

In addition, two or more computing systems, databases or devices may be substituted for any one of the systems, databases or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

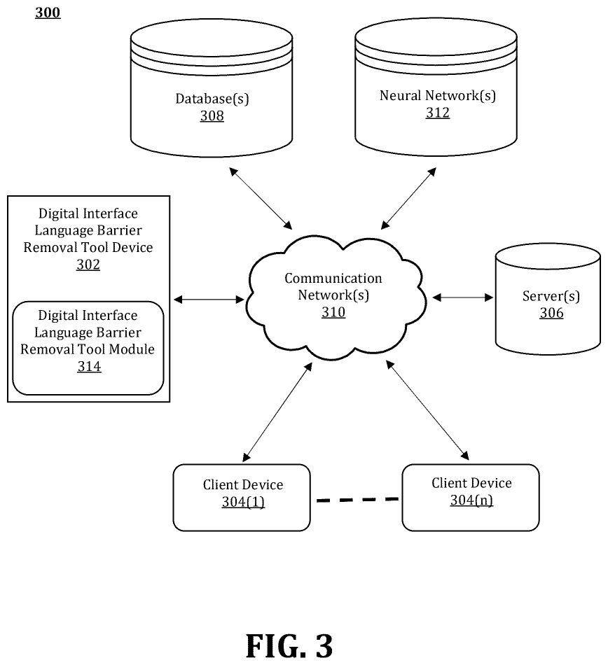

The GLBRT device 302 is described and illustrated in FIG. 3 as including digital interface language barrier removal tool module 314, although it may include other rules, policies, modules, databases, or applications, for example. As will be described below, digital interface language barrier removal tool module 314 is configured to implement event consumer application deployment control within at least one electronic event mesh, such as communication network(s) 310, for example. digital interface language barrier removal tool module 314 may include software that is based on microservices architecture, for example.

Digital interface language barrier removal tool module 314 may be integrated with one or more devices or apparatuses, such as client devices 304(1)-304(n), where digital interface language barrier removal tool module 314 may be implemented as an application or as an addon or plugin to another application of the one or more devices or apparatuses, and where digital interface language barrier removal tool module 314 may execute in the background.

A configuration 300 for applying event consumer application deployment control within an aspect of the network environment of FIG. 2 is illustrated as being executed in FIG. 3. Specifically, client devices 304(1)-304(n) are illustrated as being in communication with GLBRT device 302. In this regard, a first client device 304(1) and at least a second client device 304(2) may be “clients” of the GLBRT device 302 and are described herein as such. Nevertheless, it is to be known and understood that client device 304(1) and/or at least client device 304(2) need not necessarily be “clients” of the GLBRT device 302, or any entity described in association therewith herein. Any additional or alternative relationship may exist between client device 304(1), client device 304(2) and GLBRT device 302.

GUI language barrier removal tool module 314 of GLBRT device 302 may communicate with at least one database and/or repository, such as database(s) 308. Thereby, as described in further detail below, GLBRT device 302 may utilize one or more local and/or network repositories to store at least one from among data, parameters, features, attributes, algorithms, software, datasets and/or other information for removing language barriers from digital interface-generated objects.

In addition, digital interface language barrier removal tool module 314 of GLBRT device 302 may communicate with neural network(s) 312. Thereby, as described in further detail below, GLBRT device 302 may utilize neural network(s) 312 to process data.

In an embodiment, digital interface language barrier removal tool module 314 may be configured to provide a dynamically customizable interface for selecting, to communicate with, at least one server device at least one from among server devices 306(1)-306(n). Moreover, GLBRT device 302 may receive and transmit data via communication network(s) 210. GLBRT device 302 may receive and transmit data such as code that is written in one or more of the following dialects: transaction control language (TCL), data manipulation language (DML), data control language (DCL) and data definition language (DDL). Additionally, via communication network(s) 310, GLBRT device 302 may respectively receive and transmit data from and to one or more from among client devices 304(1)-304(n) and the server devices 306(1)-306(n).

However, FIG. 3 depicts client device 304(1) and at least client device 304(n) as belonging to communication network(s) 310, and GLBRT device 302 may communicate with any one or more devices or apparatuses that belong to the communication network(s) 310, such as one or more from among client devices 304(1)-304(n). For example, GLBRT device 302 may utilize a digital interface to communicate with one or more from among client devices 304(1)-304(n), and communication network(s) 310 may comprise a cluster that belongs to the above-mentioned enterprise that may be secured against eavesdropping. In a further embodiment, communication network(s) 310 may comprise a cluster of distributed applications that belong to the enterprise.

Client device 304(1) may be, for example, a smart phone. Of course, client device 304(1) may be any additional device described herein. Client device 304(n) may be, for example, a personal computer (PC). Of course, client device 304(n) may also be any additional device described herein.

The client devices 304(1)-304(n) may represent, for example, computer systems of the enterprise's client network. Client device 304(1) may represent, for example, one or more computer systems of a client or of a cluster of clients within the enterprise or client network. Of course, client device 304(1) may include one or more of any of the devices described herein. Client device 304(n) may be, for example, one or more computer systems of another client or cluster of clients within the enterprise or client network. Of course, client device 304(n) may include one or more of any of the devices described herein.

The herein-disclosed process(es) may be executed via the communication network(s) 310, which may comprise a plurality of networks, as described above. For example, in an embodiment, either or both of client device 304(1) and client device 204(n) may communicate with the GLBRT device 302 via broadband or cellular communication. Of course, these embodiments are merely exemplary and are not limiting or exhaustive.

GUI language barrier removal tool module 314 may programmatically configure and communicate with client devices 304(1)-304(n), which may respectively correspond to one or more remote clusters of endpoints, for example.

GUI language barrier removal tool module 314 may execute a process that programmatically configures and communicates with one or more client devices from among client devices 304(1)-304(n). In embodiments, at least one (and possibly each) from among server devices 306(1)-306(n) may comprise a neural network that provides artificial intelligence and/or machine learning (AI/ML) services within communication network(s) 310.

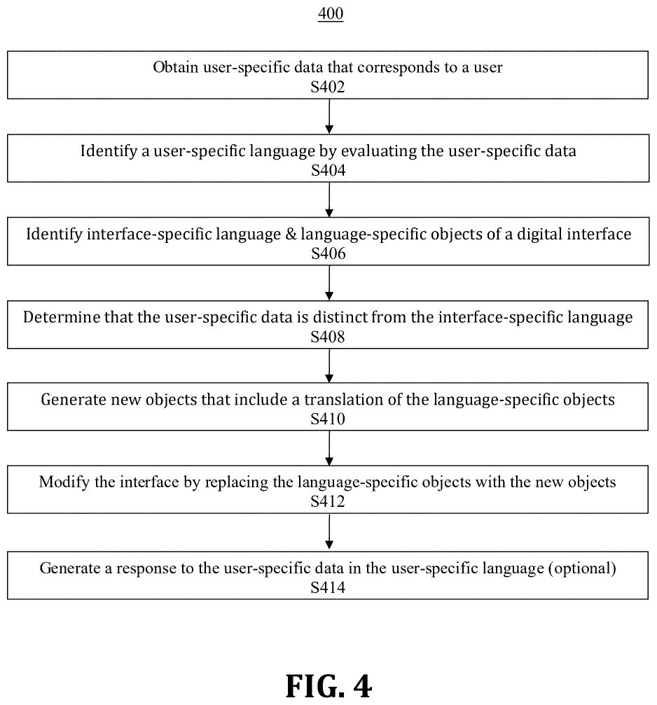

A process for removing language barriers from digital interface-generated objects is generally indicated in FIG. 4 at flowchart 400. Process 400 may be implemented by a digital interface language barrier removal tool, such as digital interface language barrier removal tool 202, digital interface language barrier removal tool device 302 and/or digital interface language barrier removal tool module 314.

At step S402, the digital interface language barrier removal tool may obtain user-specific data that corresponds to a user of at least one digital interface, such as at least one voice interface and/or graphical interface, e.g., GUIs, etc. Obtaining the user-specific data may comprise obtaining the user-specific data in real time from memory and/or an input device, such as at least one from among a keyboard, a microphone, and/or a camera (which may be used to extract the user-specific data from visual data, e.g., by reading lips, sign language and/or other visual indications/cues). The user-specific data may be obtained by pulling the user-specific data and/or by monitoring an input (or memory) for receipt of the user-specific data.

At step S404, the digital interface language barrier removal tool may identify at least one user-specific language by analyzing the user-specific data. The at least one user-specific language may comprise at least one from among a first language, a first dialect, and an indication of a first root origin of the user.

During step S404, the digital interface language barrier removal tool may determine that the first language is distinct from at least one from among the first dialect and the first root origin of the user and, in response to this determination, the digital interface language barrier removal tool may determine that the at least one user-specific language corresponds to the at least one from among the first language and the first root origin of the user.

It should be noted that although users may utilize a particular language and dialect to communicate, some individuals may not be able communicate in (or with) a different dialect of that particular language. Additionally, it should also be noted that although someone may attempt to communicate in a particular language, that particular language may not be a language in which that person is fluent. Therefore, this person may express or communicate in the particular language with accents (or with expressions) that are unusual for that particular language. As a result, these accents (and/or expressions) may be utilized by the digital interface language barrier removal tool to determine the root origin (which may be a linguistic and/or geographic origin) of the accent (or expressions).

At step S406, the digital interface language barrier removal tool may identify, by analyzing at least one digital interface of the user, at least one digital interface-specific language and a first set of language-specific objects that are generated, by the at least one digital interface, according to the at least one digital interface-specific language. The first set of language-specific objects may comprise at least one from among a label, a menu, a form, and a feedback prompt.

According to approaches disclosed herein, the digital interface language barrier removal tool may utilize at least one neural network (such as neural network(s) 312, for example) to perform at least one from among steps S404, S406, and the identification of at least one from among the at least one user-specific language, the at least one digital interface-specific language and the first set of language-specific objects. However, other processing architectures and/or machine learning and artificial intelligence (AI/ML) platforms may be utilized as well.

The at least one neural network may include at least one AI/ML model that is configured to identify at least one from among a language, a dialect and a root origin, by analyzing at least one from among corresponding user-specific data and at least one corresponding digital interface. The at least one neural network may have been trained on a plurality of annotated examples of computer-generated language-specific objects.

The digital interface language barrier removal tool may have at least one neural network perform operations to identify at least one from among the at least one user-specific language, the at least one digital interface-specific language and the first set of language-specific objects. These operations of the at least one neural network may comprise: calculating a confidence score that is based on a parallelized inference; determining that the confidence score comprises at least a ninety-five percent (95%) confidence in the parallelized inference; associating the parallelized inference with the at least one from among the language, the dialect and the root origin of the user; and prioritizing the parallelized inference when both: (i) the at least one from among the language, the dialect and the root origin of the user comprises a plurality of parallelized inferences; and (ii) the confidence score comprises a highest confidence score that has been calculated for the plurality of parallelized inferences.

Subsequently, at step S408, the digital interface language barrier removal tool may determine that the at least one digital interface-specific language is distinct from the at least one user-specific language. However, if the digital interface language barrier determines that these languages are the same, process 400 may end (and/or process 400 may be performed on another digital interface).

At step S410, the digital interface language barrier removal tool may utilize the at least one user-specific language to generate a second set of language-specific objects that comprise at least one user-specific translation of at least one respectively corresponding language-specific object from among the first set of language-specific objects. The at least one user-specific translation may also comprise at least one respectively corresponding relocation of at least one language-specific object of the at least one digital interface.

At step S412, the digital interface language barrier removal tool may modify the first set of language-specific objects, by utilizing the second set of language-specific objects to replace the at least one respectively corresponding language-specific object, respectively.

Optionally, at step S414, the digital interface language barrier removal tool may generate at least one response to the user-specific data according to the user-specific language, and the at least one response to the use-specific data may be transmitted to (and/or via) the at least one digital interface. However, although step S414 is depicted as following step S412, please note that after step S412 and/or S414, process 400 may end (and/or process 400 may be performed on a different digital interface).

Accordingly, this invention discloses a computer-implemented system for automatically detecting a user's native language, dialect, and root origin using a neural network, such as a convolutional neural network, for example. Once the detection confidence exceeds 95%, the system may dynamically adapt its user interface (e.g., labels, menus, and responses) to match the identified native tongue.

The neural network may leverage hardware-accelerated parallel computations to process extensive linguistic datasets in real time. Its architecture may support an input context window of up to 32,000 tokens, employ up to four convolutional layers, and enable detection of 100 global languages plus 5 dialects per language, where applicable.

By integrating language detection and instantaneous UI adaptation, the approach described herein improves digital interfaces (e.g., web, mobile, voice and avatar interfaces) by making them more user-friendly. Accordingly, the approaches described herein may be utilized to detect and localize languages and dialects in real time, then to adapt digital interfaces based on the detected linguistic attributes.

The automatic native tongue detection of the present approach: utilizes a hardware-accelerated neural network model trained on 100,000+ annotated language samples; identifies language, dialect, and root origin with a confidence threshold of at least 95%; and extracts phonetic, morphological, and contextual features not manually feasible at scale.

According to the dynamic interface adaptation of the present approach, once detection is validated, the system may update labels, menus, feedback prompts, and other UI elements to align with the detected language or dialect. Parallel data processing may be leveraged to perform these operations in real time, e.g., milliseconds.

The robust architecture of the herein-described neural networks may be configured to: (i) handle an input context window of up to 32,000 tokens; (ii) incorporate phonetic filtering and hidden layers prior to up to four convolutional layers; and (iii) supports 100 languages in a primary output layer and up to five dialects per language in a secondary branching layer.

Additionally, the multi-modal support of the herein-disclosed approach: (i) may integrate easily with web, mobile, voice and avatar interfaces; and (ii) may be extended to support mathematical languages or symbolic notations.

The computing environment of the herein-described approaches may be implemented on servers or devices that are equipped with multi-core CPUs, GPUs or AI accelerators that enable large-scale parallel computing. In addition, the computing environment of the herein-described approaches may comprise: memory components that store the trained neural network model; and network interfaces that handle real time data exchange from user devices.

The input module of the herein-described approaches may obtain user input from a keyboard, microphone, or touchscreen. Additionally, the input module of the herein-described approaches may comprise a DSP or GPU-based preprocessing engine that extracts relevant linguistic and phonetic features.

The custom neural network model architecture of the herein-described approaches may include: a 32,000-token context window that captures broad context for complex linguistic cues; contextual and phonetic filtering that isolates relevant features and discards noise; hidden input layers that transform and normalize preprocessed data into a suitable feature space; four convolutional layers that detects nuanced n-gram patterns, phonetic transitions, and syntactic structures; and output layers that comprise (i) primary classification among 100 global languages and (ii) secondary classification to identify up to 5 dialects of each language, if data is available.

The output and interface adaptation of the herein-described approaches may immediately produce localized textual or spoken responses using natural language generation. In addition, when the detection confidence is determined to be at least 95%, the output and interface adaptation of the herein-described approaches may update user interface (UI) elements/objects (e.g., buttons, labels, feedback windows) in real time.

The language(s) described herein may comprise: English, Mandarin (and/or Cantonese) Chinese, Hindi, Spanish, French, Arabic (Modern Standard), Bengali, Russian, Portuguese, Urdu, Indonesian, German, Japanese, Swahili, Marathi, Telugu, Turkish, Tamil, Vietnamese, Korean, Italian, Thai, Gujarati, Punjabi, Polish, Ukrainian, Persian (Farsi), Malay (Bahasa Melayu), Burmese (Myanmar), Sundanese, Cantonese (Chinese), Yoruba, Romanian, Dutch, Greek, Hungarian, Czech, Haitian Creole, Kinyarwanda, Shona, Kirundi, Somali, Kazakh, Khmer, Madurese, Zulu, Tagalog (Filipino), Xhosa, Odia (Oriya), Tigrinya, Pashto, Nepali, Sinhalese, Amharic, Azerbaijani (Azeri), Lao, Kurdish, Serbian (Serbo-Croatian variants), Armenian, Mongolian, Hebrew, Belarusian, Bulgarian, Hmong, Slovak, Danish, Finnish, Norwegian, Swedish, Catalan, Croatian (Serbo-Croatian variants), Lithuanian, Latvian, Slovenian, Estonian, Basque, Luxembourgish, Icelandic, Irish (Gaelic), Maltese, Welsh, Albanian, Cebuano, Javanese, Filipino (Tagalog-based), Jamaican Creole (Patois), Hausa, Igbo, Lingala, Afrikaans, Maori, Georgian, Tibetan, Uyghur, Quechua, Guarani, Tongan, Samoan, Navajo (Diné Bizaad), Maori Sign Language, and more, for example.

According to the approaches described herein, for each language, the system can detect up to 5 dialects, such as: English (such as American, British, Australian, Indian, and Jamaican dialects, for example); Spanish (such as Castilian, Latin American, Rioplatense, Caribbean, and Andean dialects, for example); Arabic (such as Egyptian, Levantine, Maghrebi, Gulf, and modern standard dialects, for example); Chinese Mandarin (such as Mainland Standard, Taiwanese, Singaporean, Southwestern, and Northeastern dialects, for example); and French (such as Metropolitan (France), Canadian, African, Haitian Creole, and Belgian, for example).

According to the approaches described herein, the logic flow may comprise operations that include: (i) input reception (data such as text or speech may be obtained through an input module); (ii) preprocessing (high-throughput DSP and/or GPU may filter out noise, extracts phonetic/morphological features); (iii) the neural network may make at least one inference where the trained neural network runs parallelized matrix operations, outputs language/dialect probabilities, and checks for a 95% confidence threshold; (iv) UI adaptation, which may respond in the identified tongue and, if threshold is met, the system may update labels, forms, menus, and feedback; and (v) failure mode (which may comprise falling back to a default language, or requesting user clarification, when confidence falls below 95%).

Therefore, the approaches described herein may utilized for the following applications: web e-commerce (a retail site detects a shopper's typed queries, adapts product listings and checkout flows to that user's language, boosting sales); government services portal or web (online forms automatically switch to the citizen's dialect, improving accessibility and comprehension); multilingual messaging app or mobile device (group chats seamlessly translate text for each participant and localize the app interface in real time); travel digital interfacede app or mobile device (provides route info and cultural tips in the traveler's dialect, with a local spin, e.g., metric vs. imperial); voice-driven assistant voice (a smart speaker tailors its accent, phrasing, and idiomatic expressions based on the user's initial voice input); customer support IVR voice (rapidly detects a caller's language, routes them to a dialect-appropriate agent or customizes the IVR prompts); virtual teacher avatar (learners receive tailored lessons and accent demonstrations that match their dialect, enhancing understanding); interactive gaming NPCs or avatars (non-player characters adapt to the gamer's spoken dialect, personalizing in-game dialogue); in-car infotainment voice (vehicle UI and voice prompts shift to the driver's local dialect for clarity and comfort); and telemedicine platform web or mobile device (patients receive medical instructions and forms in their dialect, ensuring higher accuracy and compliance).

Thereby, the approaches described herein may be utilized to provide a technical solution for computer-generated language barriers by leveraging parallel hardware processing, a custom multi-layer neural network model, and real-time user interface updates. The system's design ensures global accessibility, scalable language expansion, and seamless user interactions across a wide array of devices and modes.

Although the invention has been described with reference to several embodiments, it is understood that the words that have been used are words of description and illustration, rather than words of limitation. Changes may be made within the purview of the appended claims, as presently stated and as amended, without departing from the scope and spirit of the present disclosure in its aspects. Therefore, applications of the present disclosure are not limited to electronic resource usage efficiency improvements and may be extended to provide a technical improvement to efforts in other technological areas.

Accordingly, although the invention has been described with reference to particular means, materials and embodiments, the invention is not intended to be limited to the particulars disclosed, rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method of implementing a digital interface language barrier removal tool, the method comprising:
obtaining user-specific data that corresponds to a user;
identifying, by analyzing the user-specific data, at least one user-specific language;
identifying, by analyzing at least one digital interface of the user, at least one digital interface-specific language and a first set of language-specific objects that are generated, by the at least one digital interface, according to the at least one digital interface-specific language;
when the at least one digital interface-specific language has been determined to be distinct from the at least one user-specific language, utilizing the at least one user-specific language to generate a second set of language-specific objects that comprise at least one user-specific translation of at least one respectively corresponding language-specific object from among the first set of language-specific objects; and
modifying, the first set of language-specific objects, by utilizing the second set of language-specific objects to replace the at least one respectively corresponding language-specific object, respectively.

2. The method of claim 1, wherein the first set of language-specific objects comprises at least one from among a label, a menu, a form, and a feedback prompt.

3. The method of claim 1, wherein the obtaining of the user-specific data comprises:
obtaining the user-specific data in real time from at least one from among a keyboard and a microphone.

4. The method of claim 1, further comprising generating at least one response to the user-specific data according to the user-specific language.

5. The method of claim 1, wherein the at least one user-specific language comprises at least one from among a first language, a first dialect and an indication of a first root origin of the user.

6. The method of claim 5, wherein the identifying of the at least one user-specific language comprises:
when the first language has been determined to be distinct from at least one from among the first dialect and the first root origin of the user, determining that the at least one user-specific language corresponds to the at least one from among the first language and the first root origin of the user.

7. The method of claim 1, further comprising:
utilizing at least one neural network to identify the at least one user-specific language, the at least one digital interface-specific language and the first set of language-specific objects,
wherein the at least one neural network includes at least one machine learning and artificial intelligence (AI/ML) model that is configured to identify at least one from among a language, a dialect and a root origin, by analyzing at least one from among corresponding user-specific data and at least one corresponding digital interface.

8. The method of claim 7, wherein the at least one neural network has been trained on a plurality of annotated examples of computer-generated language-specific objects.

9. The method of claim 7, wherein identifying each of the at least one from among the language, the dialect and the root origin of the user, comprises:
calculating, by the at least one neural network, a confidence score that is based on a parallelized inference;
when the confidence score has been determined to comprise at least a ninety-five percent confidence in the parallelized inference, associating the parallelized inference with the at least one from among the language, the dialect and the root origin of the user; and
prioritizing the parallelized inference when:
the at least one from among the language, the dialect and the root origin of the user comprises a plurality of parallelized inferences; and
the confidence score comprises a highest confidence score that has been calculated for the plurality of parallelized inferences.

10. The method of claim 1, wherein the at least one user-specific translation comprises at least one respectively corresponding relocation of at least one language-specific object of the at least one digital interface.

11. A system of implementing a digital interface language barrier removal tool, the system comprising:
a processor; and
memory that stores instructions that, when executed by the processor, cause the processor to perform operations that comprise:
obtaining user-specific data that corresponds to a user;
identifying, by analyzing the user-specific data, at least one user-specific language;
identifying, by analyzing at least one digital interface of the user, at least one digital interface-specific language and a first set of language-specific objects that are generated, by the at least one digital interface, according to the at least one digital interface-specific language;
when the at least one digital interface-specific language has been determined to be distinct from the at least one user-specific language, utilizing the at least one user-specific language to generate a second set of language-specific objects that comprise at least one user-specific translation of at least one respectively corresponding language-specific object from among the first set of language-specific objects; and
modifying, the first set of language-specific objects, by utilizing the second set of language-specific objects to replace the at least one respectively corresponding language-specific object, respectively.

12. The system of claim 11, wherein when executed by the processor, the instructions cause the identifying of the at least one user-specific language to comprise:
when a first language has been determined to be distinct from at least one from among a first dialect and a first root origin of the user, determining that the at least one user-specific language corresponds to the at least one from among the first language and the first root origin of the user.

13. The system of claim 11, when executed, the instructions cause the processor to perform further operations, which comprise:
utilizing at least one neural network to identify the at least one user-specific language, the at least one digital interface-specific language and the first set of language-specific objects,
wherein the at least one neural network includes at least one machine learning and artificial intelligence (AI/ML) model that is configured to identify at least one from among a language, a dialect and a root origin, by analyzing at least one from among corresponding user-specific data and at least one corresponding digital interface.

14. The system of claim 13, wherein the at least one neural network has been trained on a plurality of annotated examples of computer-generated language-specific objects.

15. The system of claim 13, wherein when executed by the processor, the instructions cause identifying each of the at least one from among the language, the dialect and the root origin of the user, to comprise:
calculating, based on a parallelized inference of the at least one neural network, a confidence score;
when the confidence score has been determined to comprise at least a ninety-five percent confidence in the parallelized inference, associating the parallelized inference with the at least one from among the language, the dialect and the root origin of the user; and
prioritizing the parallelized inference when:
the at least one from among the language, the dialect and the root origin of the user comprises a plurality of parallelized inferences; and
the confidence score comprises a highest confidence score that has been calculated for the plurality of parallelized inferences.

16. The system of claim 11, wherein when executed by the processor, the instructions cause the at least one user-specific translation to comprise:
at least one respectively corresponding relocation of at least one language-specific object of the at least one digital interface.

17. A non-transitory computer-readable medium of implementing a digital interface language barrier removal tool, the computer-readable medium storing instructions that, when executed by a processor, cause the processor to perform operations that comprise:
obtaining user-specific data that corresponds to a user;
identifying, by analyzing the user-specific data, at least one user-specific language;
identifying, by analyzing at least one digital interface of the user, at least one digital interface-specific language and a first set of language-specific objects that correspond to a first set of language-specific objects that are generated, by the at least one digital interface, according to the at least one digital interface-specific language;
when the at least one digital interface-specific language has been determined to be distinct from the at least one user-specific language, utilizing the at least one user-specific language to generate a second set of language-specific objects that comprise at least one user-specific translation of at least one respectively corresponding language-specific object from among the first set of language-specific objects; and
modifying, the first set of language-specific objects, by utilizing the second set of language-specific objects to replace the at least one respectively corresponding language-specific object, respectively.

18. The computer-readable medium of claim 17, when executed, the instructions cause the processor to perform further operations, which comprise:
utilizing at least one neural network to identify the at least one user-specific language, the at least one digital interface-specific language and the first set of language-specific objects,
wherein the at least one neural network includes at least one machine learning and artificial intelligence (AI/ML) model that is configured to identify at least one from among a language, a dialect and a root origin, by analyzing at least one from among corresponding user-specific data and at least one corresponding digital interface.

19. The computer-readable medium of claim 18, wherein the at least one neural network has been trained on a plurality of annotated examples of computer-generated language-specific objects.

20. The computer-readable medium of claim 18, wherein when executed by the processor, the instructions cause identifying each of the at least one from among the language, the dialect and the root origin of the user, to comprise:
calculating, based on a parallelized inference of the at least one neural network, a confidence score;
when the confidence score has been determined to comprise at least a ninety-five percent confidence in the parallelized inference, associating the parallelized inference with the at least one from among the language, the dialect and the root origin of the user; and
prioritizing the parallelized inference when:
the at least one from among the language, the dialect and the root origin of the user comprises a plurality of parallelized inferences; and
the confidence score comprises a highest confidence score that has been calculated for the plurality of parallelized inferences.
